(19) United States
(12) Patent Application Publication
(10) Pub. No.: US 2023/0364711 A1
(43) Pub. Date: Nov. 16, 2023

(54) LASER WELDING SYSTEM FOR SEALINGLY WELDING A CELL TOP COVER AND CORRESPONDING METHOD

(71) Applicant: TRUMPF (China) Co., LTD., Jiangsu (CN)

(72) Inventors: Franz Lehleuter, Shanghai (CN); Yuan Liu, Jiangsu (CN); Zekai Hou, Jiangsu (CN)

(21) Appl. No.: 18/356,248

(22) Filed: Jul. 21, 2023

Related U.S. Application Data
(63) Continuation of application No. PCT/CN2022/073483, filed on Jan. 24, 2022.

(30) Foreign Application Priority Data
Jan. 22, 2021 (CN) 202110089300.1
Jan. 22, 2021 (CN) 202120180161.9

(51) Int. Cl. B23K 26/082; B23K 31/12; B23K 26/20; B23K 26/03

(52) U.S. Cl. CPC B23K 26/082; B23K 31/125; B23K 26/206; B23K 26/032

(57) ABSTRACT

A laser welding system for sealing welding a cell top cover includes a laser emitting device for generating a scanning welding laser beam to be irradiated to a portion of the cell top cover to be welded, and a control device for controlling the laser emitting device to perform continuous scanning sealing welding on the cell top cover. The laser welding system is configured to complete the sealing welding of the cell top cover at only one work station.

### CROSS REFERENCE TO RELATED APPLICATIONS

This application is a continuation of International Application No. PCT/CN2022/073483 (WO 2022/156800 A1), filed on Jan. 24, 2022, and claims benefit to Chinese Patent Application No. CN 202110089300.1, filed on Jan. 22, 2021 and to Chinese Patent Application No. CN 202120180161.9, filed on Jan. 22, 2021. The aforementioned applications are hereby incorporated by reference herein.

### FIELD

This disclosure relates to a laser welding system for sealingly welding a cell top cover and a method for sealingly welding a cell top cover.

### BACKGROUND

With the advance of technology and the increasingly stringent requirements of environmental protection, more and more equipment have been using batteries as the power source. For example, electric vehicles have developed rapidly in recent years, which have a tendency to gradually replace conventional vehicles.

As the smallest constituent unit of the power battery, cells can form a module, and modules can form a battery pack. The cell is an electric energy storage unit and thus must have a higher energy density to store as much electric energy as possible. The life span of the cell is also the most critical factor, since the damage of any one cell may result in damage to the entire battery pack.

The fabrication method of the cell is not only related to the quality of the cell itself, but also determines the manufacturing efficiency. The battery pack usually comprises a number of cells. Therefore, it is important to select an efficient fabrication method.

In the fabrication process of cells, a very important step is to sealingly weld cell top covers. The known continuous sealing welding step (that is, the main welding step) for sealingly welding cell top covers mainly uses a solid-state welding head (also referred to as collimating welding head or collimating emitting head), which is mounted on a linear motor to weld in a closed shape (usually a closed rectangle) around the cell top cover. In the case of a closed rectangle, it generally has four small rounded corners.

The major disadvantage of this type of welding is that the welding speed is limited by the acceleration and deceleration of the motor. To be specific, the motor needs to decelerate when approaching a corner position and accelerate when leaving the corner. Such repeated acceleration and deceleration will affect the welding speed. The welding speed of this welding manner usually does not exceed 250 mm/s. Moreover, such acceleration and deceleration will cause inconsistency in the weld pool depth of the welding area, in particular the deceleration area (e.g., the corner area).

Furthermore, in the prior art, there is no visual positioning of the welding of cell top covers before the welding, no monitoring of the weld pool depth during the welding, and no monitoring of the surface quality after the welding. All these have an influence on the welding quality and the rate of finished product as well.

In addition, in the known welding technology, in addition to the above-mentioned continuous sealing welding step, sealing welding further includes a laser pre-welding step, in particular spot welding. The pre-welding step needs to be performed at a work station before a work station for the continuous sealing welding, and then the pre-welded cell top cover is transferred to a continuous sealing welding work station for continuous sealing welding. In this situation, it requires not only more investment in equipment, but also more occupied area, and the welding system is relatively complicated.

For this reason, corresponding improvements are needed.

### SUMMARY

Embodiments of the present disclosure provide a laser welding system for sealing welding a cell top cover. The laser welding system includes a laser emitting device for generating a scanning welding laser beam to be irradiated to a portion of the cell top cover to be welded, and a control device for controlling the laser emitting device to perform continuous scanning sealing welding on the cell top cover. The laser welding system is configured to complete the sealing welding of the cell top cover at only one work station.

Embodiments of the present disclosure provide an improved laser welding system for sealingly welding a cell top cover and a corresponding sealing welding method to overcome at least one of the above-mentioned disadvantages.

According to one aspect of the disclosure, a laser welding system for sealingly welding a cell top cover is provided, the laser welding system comprising: a laser emitting device for generating a scanning welding laser beam which is irradiated to a portion to be welded of the cell top cover; and a control device at least for controlling the laser emitting device to perform continuous scanning sealing welding on the cell top cover, wherein the laser welding system is configured to complete sealing welding of the cell top cover at only one work station.

According to an exemplary embodiment of the disclosure, the laser emitting device is configured to operate based on a BrightLine Welding (BLW) technology. For the BrightLine Welding technology, please refer to the contents disclosed in the published Chinese patent document CN 109982807 A, which is incorporated herein in its entirety by reference.

According to an exemplary embodiment of the disclosure, the laser welding system is configured to continuously perform closed-loop welding on the cell top cover; and/or the laser welding system is configured to weld at a scanning welding speed of up to 10,000 mm/s.

According to an exemplary embodiment of the disclosure, the laser welding system further comprises one or more of the following: a positioning device at least for achieving pre-positioning before welding; an in-welding weld pool depth monitoring device for monitoring a depth of weld pool during the continuous scanning sealing welding process; and

a post-welding surface quality monitoring device for monitoring the quality of a welded surface.

According to an exemplary embodiment of the disclosure, the positioning device is configured as a first vision device; and/or the positioning device is configured to be adapted to achieve customized programming based on the size and configuration of a sample; and/or the positioning device is in communication connection with the control device; and/or the positioning device is in communication connection with the laser emitting device.

According to an exemplary embodiment of the disclosure, the positioning device is configured to be adapted to obtain characteristic data of the cell top cover related to a subsequent continuous scanning sealing welding operation and transmit the characteristic data to the control device, and the control device is configured to be adapted to control the laser emitting device and/or a worktable for fixing the cell top cover based on the obtained characteristic data.

According to an exemplary embodiment of the disclosure, the characteristic data comprises at least one of a geometric characteristic of the cell top cover, a position characteristic of the cell top cover and a gap characteristic of the portion to be welded; and/or the laser welding system is configured to: perform the subsequent continuous scanning sealing welding operation if the characteristic data satisfies a predetermined condition, and terminate continuous scanning sealing welding or continue performing the subsequent continuous scanning sealing welding operation by adjusting the cell top cover to satisfy the predetermined condition, if the characteristic data does not satisfy the predetermined condition.

According to an exemplary embodiment of the disclosure, the laser welding system is configured to be adapted to adjust characteristics of the laser beam emitted by the laser emitting device based on a gap width characteristic and/or a gap position characteristic of the portions to be welded; and/or the laser emitting device has a controller or the control device is integrated into the laser emitting device; and/or the laser emitting device is configured as a scanning galvanometer.

According to an exemplary embodiment of the disclosure, the in-welding weld pool depth monitoring device is configured to operate based on optical coherence tomography technology; and/or the in-welding weld pool depth monitoring device is in communication connection with the control device; and/or the post-welding surface quality monitoring device is configured to determine whether the corresponding cell top cover is a qualified product based on a comparison result with a predetermined surface quality; and/or the post-welding surface quality monitoring device is configured as a second vision device; and/or the post-welding surface quality monitoring device is in communication connection with the control device.

According to an exemplary embodiment of the disclosure, the positioning device and the post-welding surface quality monitoring device are configured as a common vision device.

According to another aspect of the disclosure, a method for sealingly welding a cell top cover is provided, and the method is performed by using the laser welding system to achieve continuous scanning sealing welding of the cell top cover.

According to some embodiments of the disclosure, the speed, the quality and the level of automation of cell top cover welding can be improved, the occupied area can be reduced, and the laser welding system can be simplified.

### BRIEF DESCRIPTION OF DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic functional block diagram of a laser welding system for continuous scanning sealing welding of a cell top cover according to an exemplary embodiment of the disclosure.

### DETAILED DESCRIPTION

For a clearer understanding of the technical problems to be solved, the technical solutions and the advantageous technical effects of the disclosure, the disclosure will be further explained in detail with reference to the accompanying drawings and a number of exemplary embodiments. It should be understood that the specific embodiments described herein are only for explaining the disclosure, rather than limiting the scope of protection of the disclosure.

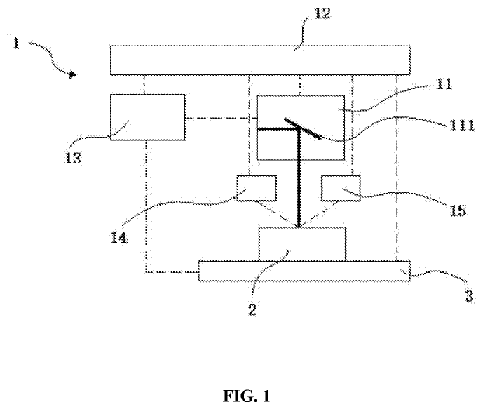

FIG. 1 shows a schematic functional block diagram of a laser welding system for continuous scanning sealing welding of a cell top cover according to an exemplary embodiment of the disclosure.

As shown in FIG. 1, a laser welding system 1 may comprise: a laser emitting device 11 for generating a scanning welding laser beam and a control device 12 at least for controlling the laser emitting device 11 to perform continuous scanning sealing welding on a cell top cover 2. During the welding process, the cell top cover 2 may be fixed on a worktable 3. The cell top cover 2 is generally made of aluminum, aluminum alloy, stainless steel, etc., and is suitable for laser welding. The worktable 3 may be a fixture.

The skilled in the art can understand that the worktable 3 may also be controlled by the control device 12, for example, to adjust a position and/or orientation of the cell top cover 2, in particular its position and/or orientation relative to the laser emitting device 11.

The skilled in the art can understand that the laser welding system 1 according to the disclosure may be stationary as a whole during the sealing welding process, and only rely on the laser emitting device 11, for example, an optical device 111 thereof, to control the laser beam to irradiate on a position of the cell top cover 2, so as to continuously weld around the cell top cover 2 in a closed-loop. In this case, the acceleration and deceleration problem of the linear motor during the conventional sealing welding process is avoided, and the welding speed can be greatly improved, for example, a scanning welding speed of up to 10,000 mm/s can be achieved.

According to an exemplary embodiment of the disclosure, the laser emitting device 11 may be configured to operate based on a BrightLine Welding technology. The BrightLine welding technology is a technology also belonging to the present applicant, which utilizes 2 in 1 laser light cable (LLK) to emit a laser beam to a workpiece to be processed, and has advantages such as reducing spatter, improving surface shaping, etc. For clarity, the specific details will not be elaborated here.

According to an exemplary embodiment of the disclosure, the laser welding system 1 may further comprise a positioning device 13 at least for achieving pre-positioning before welding, so as to allow the laser beam to move/scan relative to the cell top cover 2 in a predetermined manner, in particular allow real-time adjustment of a position of incidence of the laser beam according to the position of the cell top cover 2 to avoid damage to the workpiece or the worktable 3.

According to an exemplary embodiment of the disclosure, the positioning device 13 may be configured as a vision device. In this case, for example, the shape/contour of the cell top cover 2 may be automatically obtained through intelligent image processing technology, and the corresponding position of incidence of laser is adjusted.

According to an exemplary embodiment of the disclosure, the positioning device 13 may be configured to allow for customized programming based on the size and configuration of a sample to perform pre-positioning before welding.

As shown in FIG. 1, the positioning device 13 (in particular in the case of a visual device) may be in communication connection with the control device 12 (schematically shown by dashed lines in FIG. 1), in order to report the obtained information about the shape and the position of the cell top cover 2 and a gap characteristic of a portion to be welded (including but not limited to gap width, gap position, whether the gap is in uniformity, etc.) to the control device 12. The control device 12 may control the laser emitting device 11 and even the worktable 3 as well according to the information.

According to an exemplary embodiment of the disclosure, if the gap width is greater than a predetermined value, the control device 12 may issue an alarm to notify the worker that the cell top cover 2 that is about to be sealed and welded cannot be welded later, otherwise welding problems will occur. In this situation, the worker may adjust or remove the cell top cover 2 to avoid cost loss and increase the rate of finished product.

The skilled in the art can understand that automatic adjustment of the cell top cover 2 may also be considered so that the gap at portion to be welded can meet a predetermined condition, and then the welding can be continued.

According to an exemplary embodiment of the disclosure, the positioning device 13 may also be in communication with the laser emitting device 11 in order to control the laser emitting device 11 by means of a controller (not shown), if the laser emitting device 11 itself has one.

The controller of the laser emitting device 11 itself may also be considered as a part of the control device 12. In some cases, the control device 12 may even be integrated on the laser emitting device 11, for example, in the case of a scanning galvanometer (also known as PFO, Programming Focus Optical). The disclosure does not impose any restriction on this.

According to an exemplary embodiment of the disclosure, characteristics, such as the power, the size of focal spot, etc., of the laser beam emitted by the laser emitting device 11 may be controlled, preferably automatically controlled, according to the gap characteristics, such as a gap width, of the portion to be welded. This greatly improves the level of automation and also increases the rate of finished product.

According to an exemplary embodiment of the disclosure, the laser welding system 1 may further comprise an in-welding weld pool depth monitoring device 14 for monitoring a depth of weld pool during the continuous scanning sealing welding process. With the aid of the weld pool depth monitoring device 14, the welding state can be monitored in real time and, if needed, operation of the laser emitting device 11 can be controlled, in particular by the control device 12, in order to achieve a desired welding process.

According to an exemplary embodiment of the disclosure, the in-welding weld pool depth monitoring device 14 may be configured to operate based on optical coherence tomography technology. In this case, the depth of weld pool can be monitored in real time through tomography to determine whether the welding is performed in the desired manner.

According to an exemplary embodiment of the disclosure, the laser welding system 1 may further comprise a post-welding surface quality monitoring device 15 for monitoring the quality of a welded surface.

According to an exemplary embodiment of the disclosure, the post-welding surface quality monitoring device 15 may be configured as a vision device, such as a photographing device. In this case, it is possible to take a picture of the welded surface and then, for example, compare it with a weld seam surface in the database to determine whether it is a qualified product based on the comparison result. If it is determined to be a nonconforming product, the operator may be notified or the nonconforming product may be automatically removed by a corresponding device.

According to an exemplary embodiment of the disclosure, the post-welding surface quality monitoring device 15 may be configured to be the same as the positioning device 13, or the same device. In the latter case, it means that the positioning device 13 may perform both the pre-welding pre-positioning before welding and the quality monitoring of the welded surface after welding. In this way, it reduces not only the complexity of the laser welding system 1, but also the cost.

The laser welding system according to the disclosure may also perform pre-welding on the cell top cover 2 before the continuous scanning sealing welding operation. In other words, pre-welding and a subsequent continuous scanning sealing welding can be performed by the same laser welding system, without the need of changing the work station. Pre-welding can be regarded as one step of sealing welding.

The skilled in the art can also understand that it is even possible to skip the pre-welding process and directly perform the continuous scanning sealing welding, in particular in the situation where the fixture can reliably fix the top cover.

Although specific embodiments of the disclosure are described here in detail, they are only for the purpose of explanation and should not be considered as limiting the scope of the disclosure. Various substitutions, alterations and modifications can be conceived without deviating from the spirit and scope of the disclosure.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A laser welding system for sealing welding a cell top cover, the laser welding system comprising:
a laser emitting device for generating a scanning welding laser beam to be irradiated to a portion of the cell top cover to be welded; and
a control device for controlling the laser emitting device to perform continuous scanning sealing welding on the cell top cover,
wherein the laser welding system is configured to complete the sealing welding of the cell top cover at only one work station.

2. The laser welding system according to claim 1, wherein the laser emitting device is configured to operate based on a brightline welding technology.

3. The laser welding system according to claim 1, wherein,
the laser welding system is configured to continuously perform the sealing welding in a closed loop on the cell top cover; and/or
the laser welding system is configured to weld at a scanning welding speed of up to 10,000 mm/s.

4. The laser welding system according to claim 2, wherein,
the laser welding system is configured to continuously perform the sealing welding in a closed loop on the cell top cover; and/or
the laser welding system is configured to weld at a scanning welding speed of up to 10,000 mm/s.

5. The laser welding system according to claim 1, further comprising one or more of the following:
a positioning device for pre-positioning before the sealing welding;
an in-welding weld pool depth monitoring device for monitoring a depth of a weld pool during the continuous scanning sealing welding; or
a post-welding surface quality monitoring device for monitoring a quality of a welded surface.

6. The laser welding system according to claim 2, further comprising one or more of the following:
a positioning device for pre-positioning before the sealing welding;
an in-welding weld pool depth monitoring device for monitoring a depth of a weld pool during the continuous scanning sealing welding; or
a post-welding surface quality monitoring device for monitoring a quality of a welded surface.

7. The laser welding system according to claim 3, further comprising one or more of the following:
a positioning device for pre-positioning before the sealing welding;
an in-welding weld pool depth monitoring device for monitoring a depth of a weld pool during the continuous scanning sealing welding; or
a post-welding surface quality monitoring device for monitoring a quality of a welded surface.

8. The laser welding system according to claim 4, further comprising one or more of the following:
a positioning device for pre-positioning before the sealing welding;
an in-welding weld pool depth monitoring device for monitoring a depth of a weld pool during the continuous scanning sealing welding; or
a post-welding surface quality monitoring device for monitoring a quality of a welded surface.

9. The laser welding system according to claim 5, wherein,
the positioning device is configured as a first vision device; and/or
the positioning device is configured to be customized programmed based on a size and a configuration of a sample; and/or
the positioning device is communicatively connected to the control device; and/or
the positioning device is communicatively connected to the laser emitting device.

10. The laser welding system according to claim 9, wherein,
the positioning device is configured to obtain characteristic data of the cell top cover related to a subsequent continuous scanning sealing welding and transmit the characteristic data to the control device, and the control device is configured to control the laser emitting device and/or a worktable for fixing the cell top cover based on the characteristic data.

11. The laser welding system according to claim 10, wherein,
the characteristic data comprises at least one of a geometric characteristic of the cell top cover, a position characteristic of the cell top cover, or a gap characteristic of the portion of the cell top cover to be welded; and/or
the laser welding system is configured to perform the subsequent continuous scanning sealing welding if the characteristic data satisfies a predetermined condition, and to terminate the continuous scanning sealing welding, or continue performing the subsequent continuous scanning sealing welding by adjusting the cell top cover to satisfy the predetermined condition, if the characteristic data does not satisfy the predetermined condition.

12. The laser welding system according to claim 11, wherein,
the laser welding system is configured to adjust characteristics of the laser beam emitted by the laser emitting device based on a gap width characteristic and/or a gap position characteristic of the portion of the cell top cover to be welded; and/or
the laser emitting device has a controller or the control device is integrated into the laser emitting device; and/or
the laser emitting device is configured as a scanning galvanometer.

13. The laser welding system according to claim 5, wherein,
the in-welding weld pool depth monitoring device is configured to operate based on optical coherence tomography technology; and/or
the in-welding weld pool depth monitoring device is communicatively connected to the control device; and/or
the post-welding surface quality monitoring device is configured to determine whether the cell top cover is a qualified product based on a comparison result with a predetermined surface quality; and/or
the post-welding surface quality monitoring device is configured as a second vision device; and/or
the post-welding surface quality monitoring device is communicatively connected to the control device.

14. The laser welding system according to claim 6, wherein,
the in-welding weld pool depth monitoring device is configured to operate based on optical coherence tomography technology; and/or
the in-welding weld pool depth monitoring device is communicatively connected to the control device; and/or
the post-welding surface quality monitoring device is configured to determine whether the cell top cover is a qualified product based on a comparison result with a predetermined surface quality; and/or
the post-welding surface quality monitoring device is configured as a second vision device; and/or
the post-welding surface quality monitoring device is communicatively connected to the control device.

15. The laser welding system according to claim 7, wherein,
the in-welding weld pool depth monitoring device is configured to operate based on optical coherence tomography technology; and/or
the in-welding weld pool depth monitoring device is communicatively connected to the control device; and/or
the post-welding surface quality monitoring device is configured to determine whether the cell top cover is a qualified product based on a comparison result with a predetermined surface quality; and/or
the post-welding surface quality monitoring device is configured as a second vision device; and/or
the post-welding surface quality monitoring device is communicatively connected to the control device.

16. The laser welding system according to claim 8, wherein,
the in-welding weld pool depth monitoring device is configured to operate based on optical coherence tomography technology; and/or
the in-welding weld pool depth monitoring device is communicatively connected to the control device; and/or
the post-welding surface quality monitoring device is configured to determine whether the cell top cover is a qualified product based on a comparison result with a predetermined surface quality; and/or
the post-welding surface quality monitoring device is configured as a second vision device; and/or
the post-welding surface quality monitoring device is communicatively connected to the control device.

17. The laser welding system according to claim 9, wherein,
the in-welding weld pool depth monitoring device is configured to operate based on optical coherence tomography technology; and/or
the in-welding weld pool depth monitoring device is communicatively connected to the control device; and/or
the post-welding surface quality monitoring device is configured to determine whether the cell top cover is a qualified product based on a comparison result with a predetermined surface quality; and/or
the post-welding surface quality monitoring device is configured as a second vision device; and/or
the post-welding surface quality monitoring device is communicatively connected to the control device.

18. The laser welding system according to claim 10, wherein,
the in-welding weld pool depth monitoring device is configured to operate based on optical coherence tomography technology; and/or
the in-welding weld pool depth monitoring device is communicatively connected to the control device; and/or
the post-welding surface quality monitoring device is configured to determine whether the cell top cover is a qualified product based on a comparison result with a predetermined surface quality; and/or
the post-welding surface quality monitoring device is configured as a second vision device; and/or
the post-welding surface quality monitoring device is communicatively connected to the control device.

19. The laser welding system according to claim 13, wherein,
the positioning device and the post-welding surface quality monitoring device are configured as a common vision device.

20. A method for sealing welding a cell top cover, wherein the method is performed by using the laser welding system according to claim 1 to achieve continuous scanning sealing welding of the cell top cover.
